(19) United States
(12) Patent Application Publication
(10) Pub. No.: US 2020/0027035 A1
(43) Pub. Date: Jan. 23, 2020

(54) MyEticket

(71) Applicant: Aby George, Dallas, TX (US)

(72) Inventor: Aby George, Dallas, TX (US)

(21) Appl. No.: 16/041,804

(22) Filed: Jul. 22, 2018

(51) Int. Cl. G06Q 10/02; G06Q 50/30; G06Q 20/04; G06F 21/40

(52) U.S. Cl. CPC G06Q 10/02; G06Q 50/30; G06F 21/40; G06Q 20/0457; G06Q 20/0453

(57) ABSTRACT

A novel form of airport security system for passengers which allows quick and easy experience from check in to finally boarding the flight. The application takes the data from the user and make their secured login which help them to get connected with their carrier and allowing them to go easily through the security process. The system will also be able to send notifications to user if for instance check-in required. Moreover, Homeland security once connected with app, can categorize the 3 level of users which indicate good standing for green, questionable for orange, and violent behavior or wanted list personal in RED.

### BACKGROUND

### Field of the Invention

The present invention relates to an enhanced security system and more related to a provision of free passing through security checkpoints while boarding a plane.

### Description of the Related Art

With air passenger numbers expected to double globally by 2030, airports need to improve flow and speed up security. The extraction and use of passenger data by airports and airlines is a hotly debated issue. As the aviation industry considers the possibility of “risk-based” passenger screenings—meaning that travelers considered to be a security threat will be screened more rigorously than trusted travelers—the discussion about how passenger data will be used to make these categorical assessments is ongoing.

There are multiple types of systems and procedures that have been brought into the market to make the security system useful for everyone present at the airport. For instance, a Security system for correlating passengers and their baggage bearing U.S. Pat. No. 4,711,994A is issued to BTG International Inc. It discloses a method, and its associated system, for maintaining a close and accurate security surveillance of both the passengers and their baggage on a public conveyance, to ensure that, before departure, baggage is not loaded aboard the conveyance without a prior, positive indication that the owner or the passenger has, in fact, been properly boarded.

A US Patent 2,004,009,827,6A1 issued to Eastman Kodak Co discloses a method and system for passenger and baggage security control in a transportation system. It is a method for passenger and baggage security control in a transportation system is provided, comprising the steps of: acquiring a digital image of a passenger; providing a passenger boarding pass, a baggage tag, and a baggage claim check, each item bearing machine and human readable trip information, image information related to the passenger's digital image, and hidden authenticating information, the baggage tag also having an RFID device bearing said trip information; electronically scanning the machine readable information on the baggage tag when the baggage is loaded for the trip and creating and storing a list of all loaded baggage for the trip; authenticating the boarding pass by electronic scanning to detect the hidden authentication information when the boarding pass is presented; accessing the passenger digital image information and comparing the passenger's appearance to the image of the passenger; accepting the passenger for boarding when the authentication data is present and the passenger's appearance matches the passenger image; and creating and storing a list of all boarded passengers.

A CN103310511A invention discloses a passenger identity verifying security checking system and an operation method thereof. The security-checking system structurally comprises a security-checking door, passage guardrails and a speedy through door, wherein the speedy through door comprises a left side gate and a right side gate; the security-checking door and the speedy through door are connected with each other through the passage guardrails; the upper part of an inside door frame of the security-checking door is provided with a site videoing camera; the end surface of an upper cover of a box body of the left side gate is provided with a second information prompting screen and a radio frequency card reader; the end surface of an upper cover of a box body of the right side gate is provided with a touch screen, a certificate scanner and a portrait acquisition camera; the inclined side surface of the upper cover of the box body of the right side gate is provided with a first information prompting screen and a certificate card reader; the upper part of one side surface of the box body of the right side gate is provided with a passage state indicating screen; the box body of the right side gate is internally provided with a smallsized industrial personal computer. The security-checking system has the advantages of being convenient and practical and can be used for acquiring the identity information of passengers or visitors and checking the security of articles carried with the passengers or the visitors.

It has to be noted that the current invention proposes an advancement in attracting passengers to their facility, and also optimizing the passenger check-in and security processes—to improve both passenger flow and their experience. According to International Air Transport Association (IATA) more than three billion passengers traveled by air in 2013 and predicts that this number will double again by 2030. His current invention focuses on innovative way to offer personalized services for air travelers and automate processes for faster passenger flow through the airport.”

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary objective of the present invention is to provide a new way of using app to speed up passenger experience while boarding the plane and increase the security level by maintaining a backend database of the registered users and collaborating with multiple airlines.

It is the further objective of the present invention to provide an enhanced system where the application is developed specifically to help Industry in Airline, convention centers, stadiums and overcome client's challenges when passing through certain security checks.

It is further objective of the invention to provide an in-airline pre-checking counter and security gate point improve security, alert security personal in different category and also relieve the passengers from long security checks.

It is moreover the objective of the present invention to perform intelligent actions and categorize the individuals based on their historic trends and take related actions where required.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of process flow of myEticket according to the preferred embodiment of the present invention.

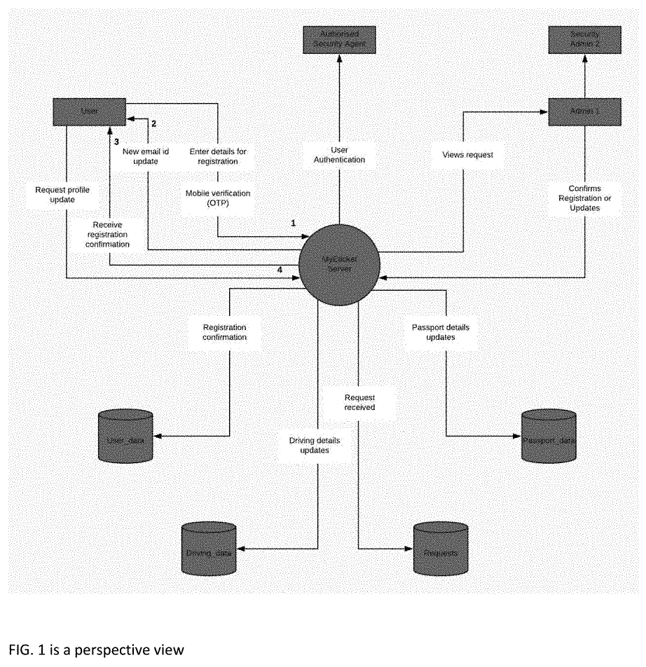

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Airports are actively working on improvement of the passenger experience and striving for a seamless flow. Examples of these efforts concern integration and simplification of the required processes, implementing new (self-service) technology and allow passengers to perform non-specific airport bound processes off-airport. However, activities that need to be carried out mainly at the airport itself include most of the safety and security processes. There is, regrettably but obviously, no doubt that security systems nowadays play a crucial role in operating an airport.

According to the preferred embodiment of the present invention in terms of personalizing and improving a traveler's journey through the airport, the current invention proposes to form a back-end database of its users. It works by identifying a passenger via the pre-input information.

The purpose of the online application is to create convenient and easy-to-use online system for passengers. Every time they board the flight, they need to pass through various security checkpoints for their identity verification. The system is based on a relational database for the profile management of the passengers.

The system in its further embodiment allows the passengers to use the system by registering at myeticket.us website and create their profile. They can submit their identity proofs on this portal, which would be later on updated in their profile by the admin. The profile uniqueness will be based on the 10-digit mobile number of the passengers.

Also, the registration to the website would require the OTP which would be sent to the given mobile number. After registration, account will be fully active only after physically authenticate with Authority.

The Airline, which is connected to myEticket application, when passenger/user once scan with open confirmation in their arrival at counter side, airline agent recognized passenger and proceeds checked-in. The airline can further notify its customers before time if boarding needed.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I. The present invention is an online application that is made to create a convenient and easy-to-use online system for passengers. Every time a passengers aboard the flight, they need to pass through various security checkpoints for their identity verification. This system is based on a relational database for the profile management of the passengers.
A method and system for electronic ticket recognition and acceptance. This method includes the step of facilitating a purchase of an electronic ticket from a networked ticketing computer. According to present invention, it allows to authenticate travelers, attendees or buyers at the entrance of restricted areas specifically in airports, convention centers and stadiums. It is, therefore, an object of the present invention for an electronic application for authenticating and confirmation holders.
How it works:
MyEticket Profile Creation (Registration): Users can register through pc or mobile app.
The Customer can download the myEticket App on the platform specific App Store. When Customer/user downloads the myEticket application, then the configuration process began and an OTP will be sent to their mobile number to authenticate user 10 digit phone number. Through this process, the myEticket app shall not only do the device hard binding, but also strongly bind the Mobile Number with the device. This process has to be mandatory.
2nd tier authentication process: During this registration process, myEticket app will create a dedicated email ID for user under same 10 digit cell number and finally onetime physical authentication will be needed with authorized security officer for full activation of users of myEticket app. This service won't allow the user to change or modify any existing information, until user change their valid ID.
The present invention according to claim no 1, provides an “enhanced my E-ticket” app securing each users and securing national interest.
The present invention according to claim no 1, is a system and method where mobile computing devices are used to display an optical symbol (e.g., QR code) that can be read by scanning devices deployed at a check in gate to fasten up or easy check-in procedure.
The present invention according to claim no 1, uses a wireless portable computing device to purchase an electronic ticket from a ticketing server. This way the user who desires the ticket can purchase immediately before the event or through an Internet or wireless connection.
The present invention according to claim no 1, MyEticket” confirmation can have multifunction and work through each individual's smart phone. User must have a USA cell number to create an account.
The present invention according to claim no 1, which is unique to each user by identifying their cell number and this 10 digit US cell number using to create its unique email identity for each person and everyone.
The present invention according to claim no 1, Users under myEticket domain, for confirmation which users receive, can uniquely open it from my box. Once the customer downloads the Apps, they could see their confirmation immediately; however, once they open the content, it may have the option to save, so customers can save for future use.
The present invention according to claim no 1, registered users can view email confirmation along with their picture and QR code which allows the users to scan easily.
